(19) United States
(12) Patent Application Publication
(10) Pub. No.: US 2002/0096866 A1
(43) Pub. Date: Jul. 25, 2002

(54) Air bag cover with single elongate tear seam

(76) Inventor: Paul B. Ireton, Miamisburg, OH (US)

Correspondence Address: KATHRYN A. MARRA, DELPHI TECHNOLOGIES, INC., Legal Staff Mail Code: 480-414-420, P.O. Box 5052, Troy, MI, 48007-5052, US

(21) Appl. No.: 09/767,033

(22) Filed: Jan. 22, 2001

(51) Int. Cl. B60R 21/16

(52) U.S. Cl. 280/731; 280/728.2

(57) ABSTRACT

A frangible air bag cover for disposition within a vehicle in covering relation to an inflatable air bag when the air bag is in an uninflated stored position. The air bag cover includes a single tear seam which extends across the interior of the air bag cover so as to form an elongate opening path for the air bag by cleaving open upon application of pressure by the air bag.

### TECHNICAL FIELD

The present invention relates to a cover for a vehicle air bag, and more particularly to a cover having a single elongate tear seam which extends substantially between opposing edges of the cover. The elongate tear seam separates upon application of force by an inflating air bag thereby cleaving the cover and permitting the air bag to exit through the opening formed by the tear seam.

### BACKGROUND OF THE INVENTION

It is well known in motor vehicle to provide an air bag module for protecting a vehicle occupant. It is also generally known to provide an air bag module including an inflatable restraint cushion and an inflator for discharging gas to inflate the cushion upon sensing predetermined vehicle conditions such as deceleration exceeding a certain level. It is also known to provide air bag modules including frangible cover elements overlying an inflatable restraint cushion and inflator in a stored position within the module wherein the cover element includes tear seams which open upon application of pressure by the inflatable restraint cushion during inflation. Several of such known air bag modules are illustrated in U.S. Pat. No. 4.903,986 to Cok et al. the contents of which are incorporated herein by reference.

In past constructions, frangible cover elements have generally been provided with seam lines running in substantially perpendicular directions so as to effect tearing both across the interior of the cover and along opposing sides thereby causing the surface of the cover element to open in substantially flap-like fashion. Accordingly, such seams have typically been arranged in substantially “H” shaped patterns and “I” shaped patterns across the interior surface of the cover so as to result in symmetrical opposing surface flaps that fold in a bending manner away from the center of the cover upon application of force by an underlying air bag cushion so as to form a centrally disposed opening through which the air bag cushion may be deployed. Symmetrical opening across the surface of such structures requires the substantially uniform propagation of a surface fracture along lateral tear seams on either side of a central tear.

### SUMMARY OF THE INVENTION

The present invention provides advantages and alternatives over the prior art by providing a frangible cover for a vehicle air bag assembly which cover includes a single tear seam extending across the inner surface of the cover substantially spanning the distance between two opposing edges. The cover is substantially free of additional tear seams running adjacent to the cover edges. Accordingly, upon the application of pressure by an underlying inflated air bag, the cover splits along a single substantially straight seam line to form an opening through which the air bag cushion may be deployed. The absence of additional perpendicular seam lines extending along the lateral edges of the cover is believed to substantially reduce the flexural strain across the surface of the cover since substantial surface bending is not required. This reduction in flexural strain thus promotes enhanced stability across the surface of the cover under a wide range of conditions, including temperature extremes that may tend to reduce the flexibility of the cover. Moreover, a substantially complete edge to edge cleavage of the cover is believed to promote the early radial expansion of the deployed air bag cushion by permitting each side of the cover to rotate outwardly away from the tear seam so as to substantially eliminate the presence of wall obstructions at the edges of the cover intersected by the seam line. In addition, the use of a single tear seam running in a single direction is believed to substantially simplify production of the cover thereby reducing the likelihood of manufacturing error.

According to one aspect of the present invention a frangible cover is provided for disposition within a vehicle in covering relation to an inflatable air bag when the air bag is in an uninflated stored position. The cover opens along a single tear seam line which extends across the interior of the frangible cover so as to substantially span the distance between opposing cover edges. The tear seam may be formed across the inner surface of the cover so as to be substantially hidden from view by a vehicle occupant viewing the exterior of the cover.

According to a further potentially preferred aspect of the present invention a frangible cover is provided for disposition within a vehicle in covering relation to an inflatable air bag when the air bag is in an uninflated position. The cover opens by surface fracture along a single elongate tear seam extending across the interior of the cover. The tear seam is of a configuration to promote initiation of cover fracture in the region near the center of the cover followed by fracture propagation away from the center and towards opposing sides.

### BRIEF DESCRIPTION OF THE DRAWINGS

The accompanying drawings which are incorporated in and which constitute a part of this specification illustrate one embodiment of the present invention and, together with the general description of the invention given above, and the detailed description set forth below, serve to explain the principles of the invention wherein:

FIG. 1 is a plan view of a steering wheel and air bag cover illustrating a tear seam arrangement according to the prior art;

FIG. 2 is a view similar to FIG. 1 illustrating a tear seam arrangement according to the present invention; and

FIG. 3 is an exploded rear perspective view of an air bag cover according to the present invention and a cooperating base plate.

While the invention has been illustrated and will be described in relation to certain potentially preferred embodiments, practices, and procedures, it is to be understood that the invention is in no way to be construed as limited to such embodiments, practices or procedures. To the contrary, it is anticipated that modifications may be made and that other embodiments of the principles of the invention may occur to those of skill in the art to which the invention pertains. Therefore, it is the intent of the applicant to cover all such modifications and embodiments as may incorporate such principles broadly within the true spirit and scope of the invention.

### DESCRIPTION OF THE PREFERRED EMBODIMENT

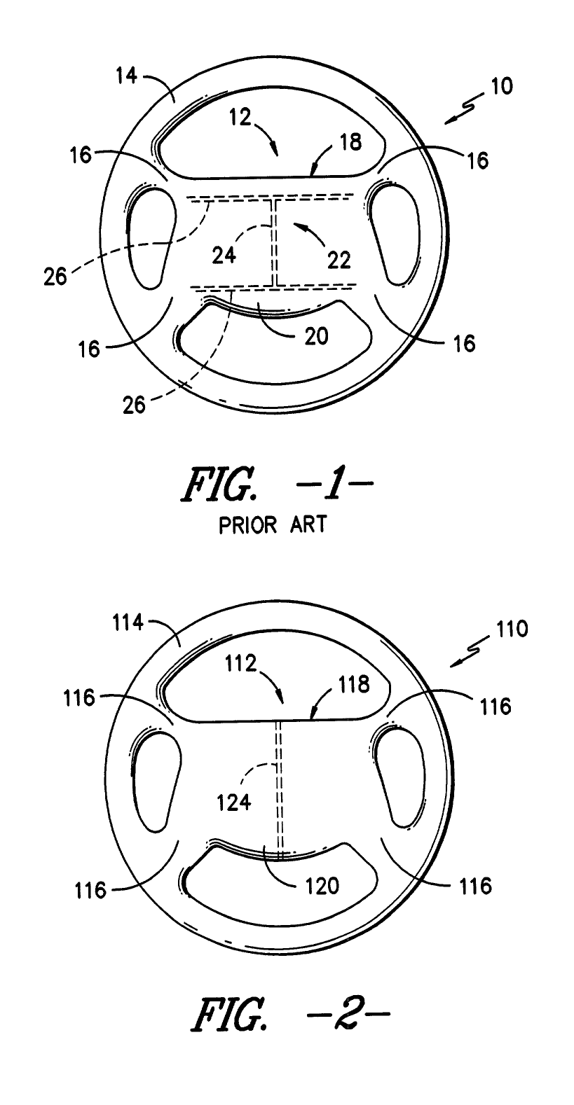

Referring to FIG. 1, a typical vehicle steering wheel 10 includes a central hub portion 12, a generally circular outer rim portion 14, and a plurality of spokes 16 which extend between the hub portion 12 and the rim portion 14. An air bag module 18 is mounted on the hub portion 12 of the steering wheel 10. The air bag module 18 typically includes a cover member 20 that overlies an inflatable air bag and gas generating inflator within the air bag module 18 in a manner as will be well known to those of skill in the art. The cover member 20 thus serves as a barrier between the operative elements of the air bag module 18 and the interior of the vehicle.

As illustrated, according to prior art embodiments, the cover member 20 typically includes a multi-directional opening pattern 22 of tear seams disposed across the underside of the cover member 20. Such prior art opening patterns 22 have typically incorporated a multiplicity of tear seams extending in different directions. In particular, such opening patterns 22 have commonly taken on substantially “I” or “H” shaped arrangements including a central tear seam 24 and lateral tear seams 26 which intersect the central tear seam 24 at substantially right angles. As shown, the lateral tear seams 26 are disposed at opposing ends of the central tear seam 24 and run in substantially parallel relation to one another along opposing edges of the cover member 20.

Upon the application of pressure by an underlying air bag cushion, the cover member 20 is forced open along the central tear seam 24 and along the lateral tear seams 26 so as to form an opening through which the inflated air bag cushion may pass. This opening is defined by the substantially flap-like regions on either side of the central tear seam 24. These flap-like regions fold outwardly away from the central tear seam 24 as the cover member fractures along the central tear seam 24 and the lateral tear seams 26. In such prior art arrangements, it has been considered desirable to initiate opening of the cover member 20 at the central tear seam 24. Thereafter, the tear seam opening is permitted to propagate along the central tear seam 24 to the lateral tear seams 26 at which point there is substantially uniform cleavage of the lateral tear seams 26 on either side of the central tear seam such that preferential opening does not occur on one side or the other of the cover member 20. The formation of an opening of appropriate size and shape in such prior art constructions is thus dependent upon the controlled tearing along multiple seam lines extending in different directions and results in a substantially centralized opening bounded by the perimeter edges of the cover member 20.

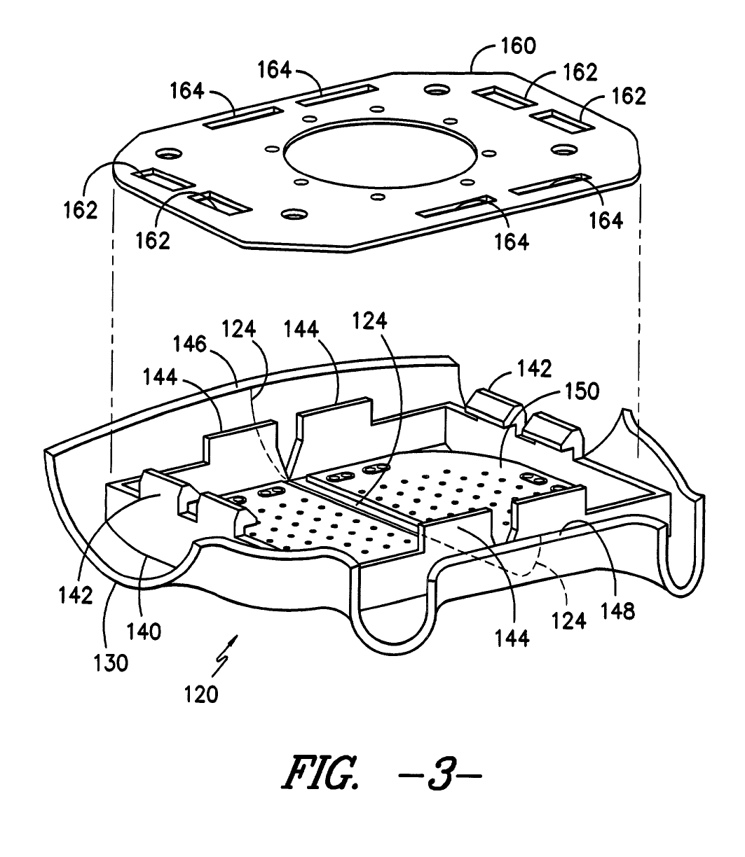

FIG. 2 illustrates an embodiment of the present invention wherein elements corresponding to those previously illustrated and described in relation to FIG. 1 are designated by corresponding reference numerals increased by 100. As shown, according to the present invention, the cover member 120 incorporates a single elongate tear seam 124 which extends across the interior of the cover member so as to open the cover member 120 in a cleaving action along a substantially straight line path. According to the illustrated and potentially preferred embodiment, the elongate tear seam will preferably run substantially down the center of the cover member from the top edge to the bottom edge although substantially horizontal or diagonal orientations are also contemplated.

By way of illustration only, and not limitation, a rear perspective view of one air bag cover according to the present invention is illustrated in FIG. 3. As illustrated, the cover member 120 may include an aesthetic face structure 130 of urethane foam or the like which is disposed in covering relation to an interior walled housing 140 of structurally stable rigid plastic or like material. The interior walled housing 140 is preferably configured to contain a folded air bag cushion (not shown) to be stored between the interior walled housing 140 and an underlying structural base plate 160 in a manner as will be well known to those of skill in the art. It is, of course to be understood that the incorporation of an aesthetic face structure 130 is optional and that the incorporation of such a feature is in no way critical to the present invention.

According to one potentially preferred practice, the cover member 120 may be formed from substantially thermoplastic materials using an injection molding process. In the event that materials of differing character are to be used in different regions of the cover member 120, a multi-shot injection molding process may be utilized. As will be appreciated, such a process yields a molded part of substantially unitary construction while nonetheless permitting the incorporation of different materials as may be desired at selected regions of the final part.

According to one practice which may be particularly preferred, the interior walled housing 140 may be formed from a relatively rigid thermoplastic material during a first injection molding shot while the aesthetic face structure 130 is formed from a softer thermoplastic material during a second injection molding shot. As will be appreciated, the relatively soft aesthetic face structure 130 may be desirable to provide a degree of external cushioning. In addition, the non-rigid character of the aesthetic face structure 130 permits compression upon the application of force by an operator within a vehicle thereby permitting actuation of an internally disposed membrane horn pad 150 in a manner as will be well known to those of skill in the art.

As illustrated, the interior walled housing 140 preferably includes one or more hook-like tab members 142 disposed along opposing lateral sides. The underlying structural base plate 160 is disposed in registry with the interior walled housing 140 such that the hook-like tab members 142 pass through cooperating openings 162 disposed along the lateral sides of the structural base plate 160. According to the illustrated and potentially preferred embodiment, the interior walled housing 140 may also include one or more substantially straight tab members 144 which pass through cooperating slotted openings 164 disposed along the upper and lower edges of the base plate. As will be appreciated, such substantially straight tab members 144 may enhance the dimensional stability of the cover member 120 relative to the structural base plate 160.

In accordance with the present invention, a single substantially straight elongate tear seam 124 extends substantially across the interior surface of the cover member 120 from the top edge 146 of the aesthetic face structure 130 to the opposing bottom edge 148 of the aesthetic face structure 130 including the interior walled housing 140. Such an arrangement of the tear seam 124 permits the cover member 120 to be cloven open in a substantially complete manner by the breakage of the single tear seam 124. Due to the orientation of the substantially hook-like tab members 142 in outboard parallel relation to the tear seam 124, the divided portions of the cover member may be pushed away from the opening formed along the tear seam 124 without causing the hook-like tab members 142 to disengage from the structural base plate 160. Conversely, in the illustrated embodiment, the substantially straight tab members 144 which are disposed in substantially perpendicular orientation to the tear seam 124 may be pulled out of the corresponding tab openings 164 substantially without interference. Due to the relatively soft nature of the aesthetic face structure 130, such material does not provide any substantial obstruction to opening of the cover member 120.

As will be appreciated, opening the cover member 120 along a single elongate tear seam 124 permits the outward rotational movement of each side of the cover member away from the tear seam 124 without the need for extensive bending across the surface of the cover member 120. Moreover, as the two sides are rotated outwardly, the perimeter edges adjacent to the ends of the tear seam 124 are lifted away from the base plate 160 thereby clearing the path for early radial expansion of the air bag cushion. Such early radial expansion may be beneficial in some instances.

According to one potentially preferred practice, the tear seam 124 is formed by a blade element across the interior surface of the cover member 120 during formation in the injection mold. However, it is also contemplated that other seam formation techniques such as laser scoring and the like may also be utilized. The tear seam 124 may be in the form either of a continuous channel or in the form of a discontinuous pattern of indentations of reduced thickness as will be well known to those of skill in the art. It is also contemplated that the tear seam may be preferentially weakened at its center so as to promote initiation of fracture at the center. By way of example only and not limitation, such preferential weakening may be effected by increasing the depth of the tear seam at the center and/or increasing the frequency, length or width of any discontinuous indentations at the center.

It is to be understood that the present invention may be adapted to a broad range of alternative constructions and that a person skilled in the art will no doubt recognize a number of modifications that nonetheless incorporate the fundamental principles of the invention. By way of example only and not limitation, it is contemplated that the substantially straight tab members 144 and the corresponding openings 164 across the structural base plate 160 may be eliminated. By way of further example, it is also contemplated that the tear seam 124 may be orientated in a substantially horizontal configuration extending between the lateral sides of cover member 120. In such a configuration, the hook-like tab members 142 are preferably disposed along the upper and lower edges 146, 148 of the interior walled housing 140. It is also contemplated that the tear seam may be formed across the exterior of the cover member 120.

It is believed that the present invention may be particularly beneficial in an air bag module 118 within a steering wheel 110 as would be typical for protection of the operator of a vehicle. However, it is contemplated that an air bag cover member 120 incorporating the single elongate tear seam of the present invention may also be utilized in relation to air bag modules in any number of other locations within the vehicle. In particular, it is contemplated that such air bag modules may be located within the instrument panel of the vehicle in generally opposing relation to a vehicle passenger as well as in the seats and/or door frames of the vehicle.

While specific embodiments of the present invention have been illustrated and described, it is to be understood that the invention is in no way to be limited to such illustrated and described embodiments since modifications may be made and other embodiments of the principles of this invention may occur to those of skill in the art to which this invention pertains. Therefore, it is intended by the appended claims to cover all such modifications and other embodiments as may incorporate the features of this invention within the true spirit and scope thereof.

1. A frangible air bag cover for disposition within a transportation vehicle which opens by fracture upon application of force by an underlying inflatable air bag cushion, the air bag cover comprising: an outer surface facing the vehicle interior and an inner surface facing away from the outer surface, the air bag cover including a single substantially straight tear seam extending across a portion of the air bag cover such that upon application of force against the inner surface, the air bag cover is caused to cleave open along the single substantially straight tear seam.

2. The invention as recited in claim 1, wherein the outer surface comprises a decorative foam and the inner surface comprises a thermoplastic of rigidity greater than that of the decorative foam.

3. The invention as recited in claim 1, wherein outwardly projecting wall elements extend away from the inner surface.

4. The invention as recited in claim 3, wherein at least a portion of the outwardly projecting wall elements comprise tab members for cooperative engagement with corresponding openings across an underlying base plate member.

5. The invention as recited in claim 4, wherein outwardly projecting wall elements comprising substantially hook-like tab members extend along perimeter edges of the inner surface in substantially parallel relation to the tear seam.

6. The invention as recited in claim 4, wherein outwardly projecting wall elements comprising substantially planar tab members extend away from the inner surface in substantially perpendicular relation to the tear seam.

7. The invention as recited in claim 1, wherein the tear seam extends substantially across the entire inner surface between opposing edges of the air bag cover.

8. A frangible air bag cover for disposition within a transportation vehicle which opens by fracture upon application of force by an underlying inflatable air bag cushion, the air bag cover comprising: an outer surface facing the vehicle interior and an inner surface facing away from the outer surface, the air bag cover including a single elongate tear seam extending substantially across the inner surface between opposing edges of the air bag cover such that upon application of force against the inner surface, the air bag cover is caused to cleave open along the tear seam.

9. The invention as recited in claim 8, wherein the outer surface comprises a decorative foam and the inner surface comprises a thermoplastic of rigidity greater than that of the decorative foam.

10. The invention as recited in claim 8, wherein outwardly projecting wall elements extend away from the inner surface.

11. The invention as recited in claim 10, wherein at least a portion of the outwardly projecting wall elements comprise tab members for cooperative engagement with corresponding openings across an underlying base plate member.

12. The invention as recited in claim 11, wherein outwardly projecting wall elements comprising substantially hook-like tab members extend away from the inner surface in substantially parallel relation to the tear seam for cooperative engagement with corresponding openings across an underlying base plate member.

13. The invention as recited in claim 12, wherein outwardly projecting wall elements comprising substantially planar tab members extend away from the inner surface in substantially perpendicular relation to the tear seam for cooperative engagement with corresponding openings across an underlying base plate member.

14. A frangible air bag cover for disposition within a transportation vehicle which opens by fracture upon application of force by an underlying inflatable air bag cushion, the air bag cover comprising: an outer surface facing the vehicle interior and an inner surface facing away from the outer surface, the air bag cover including a single elongate tear seam extending substantially across the inner surface between opposing edges of the air bag cover, and a plurality of substantially hook-like tab members extending away from the inner surface in substantially parallel relation to the tear seam for cooperative engagement with corresponding openings across an underlying base plate member such that upon application of force against the inner surface, the air bag cover is caused to cleave open along the tear seam without disengaging from the underlying base plate member at the hook-like tab members.

15. The invention as recited in claim 14, wherein outwardly projecting wall elements comprising substantially planar tab members extend away from the inner surface in substantially perpendicular relation to the tear seam for cooperative sliding engagement with corresponding openings across an underlying base plate member.

16. The invention as recited in claim 14, wherein the outer surface comprises a decorative foam and the inner surface comprises a thermoplastic of rigidity greater than that of the decorative foam.
